(19) United States
(12) Patent Application Publication
(10) Pub. No.: US 2011/0173198 A1
(43) Pub. Date: Jul. 14, 2011

(54) RECOMMENDATIONS BASED ON RELEVANT FRIEND BEHAVIORS

(75) Inventors: Prasannakumar Jobigenahally Malleshaiah, Bangalore (IN); Supreeth Hosur Nagesh Rao, Bangalore (IN)

(73) Assignee: Yahoo! Inc., Sunnyvale, CA (US)

(21) Appl. No.: 12/686,112

(22) Filed: Jan. 12, 2010

(51) Int. Cl. G06F 17/30

(52) U.S. Cl. 707/737; 707/741; 707/748; 707/E17.002; 707/E17.089

(57) ABSTRACT

Embodiments are directed towards determining dependent interest affinity values between users to identify users that may mirror interests and thereby have an increased probability of becoming friends. A plurality of tracked online activities are classified into a plurality of interests categories, and used to determine weighted scores for each interest based on a quantity and quality of related activities for the interest. A proportional score for each interest is also determined and used with the weighed scores to generate dependent interest affinities between pairs of users. Interest indices are obtained and rank ordered for a given user and another user based on relevant dependent interest affinities. The resulting interest indices may be filtered based on a variety of criteria. At least some information about the related other users may be displayed to the given user based on the rank ordering, as possible mirrored friends.

### TECHNICAL FIELD

The present invention relates generally to social networking, and, more particularly, but not exclusively to determining dependent interest affinity values between individuals to identify individuals that may mirror another user's interests and thereby have an increased probability of becoming friends.

### BACKGROUND

Tremendous changes have been occurring in the Internet that influence our everyday lives. For example, in today's society, one of the first activities that an individual might perform during their day is to turn on their computers. In fact, it appears that a large amount of time used by many individuals is spent using their computers to visit social networking sites, looking for possible friends, and building a social network of personal relationships. Making the right friends often helps in keeping one's network fun filled, expanding their relationships, learning new things, and generally improving their health and well-being. However, identifying friends is often very difficult, and time-consuming. Therefore, some individuals might turn to various matchmaking services. However, many of these services require a significant amount of initial information to be provided by the individual first joining the service.

For example, online dating search services typically require a prospective participant to select from a list of search criteria, such as gender, age, ethnicity, body type, profession, interests, and the like. After the participant has selected such criteria for someone they are looking for, the search service performs a search and may return a result of candidates whose profiles substantially match at least some of the selected criteria.

However, the list of search criteria that many online dating search services typically use are represented by a long list of forms, check boxes, radio buttons, and similar elements from which a participant is expected to select their search criteria. Some of these lists might take participant hours, if not days to complete. The result is that many users may elect not to participate in such onerous pre-search activities. Moreover, if users do not complete the search criteria activities or only provide partial criteria, then the results of their searches are more likely to lead to dissatisfaction with the service. Where the questions appear to the participant to be overly invasive, or improper, the participant might select to provide incorrect answers. Clearly, the participant might provide incorrect answers for other reasons, as well, including, for example, with intent to provide an otherwise false representation of the themselves. Thus, such mechanisms are often found to be less than useful in helping participants to find an online date.

If the participant is merely looking for friends, and not a date, such extensive initial interactions may be frustrating, resulting in the participant giving up before finding a friend. Moreover, if the person is seeking friends, and not a date, many of the services provided simply are not designed to address such relationships. Therefore, there is a desire to improve search services that at least provide a user with information about possible friends. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of an overview process for providing mirrored recommendations;

FIG. 5 illustrates a logical flow diagram generally showing one embodiment of an overview process for tracking online activities by users; and

FIG. 6 illustrates a logical flow diagram generally showing one embodiment of an overview process for use in determining interest affinities between a user and other users for use in determining mirrored recommendations.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated the present invention is directed towards combining dependent interest affinity values between individuals to identify individuals that may mirror or reflect another user's interests and thereby have an increased probability of becoming friends. In one embodiment, when a user consents, a plurality of online activities is tracked for the user. The tracked online activities may be classified into a plurality of different interest categories. Weighted scores may be determined for each of the plurality of interests based in part on a quantity and quality of a related activity for each interest. In one embodiment, the weighted scores are determined for each interest using a linear regression model. A proportional score for each interest is also determined based on the weighted scores for the interest. The proportional scores and weighted scores may then be used to determine dependent interest affinities between pairs of users over the plurality of interests. Interest indices are obtained for a given user and another user based on combinations of the dependent interest affinities between the given user and other users. In one embodiment, the resulting interest indices may be filtered based on a variety of additional criteria, including but not limited to a distance between the given user and the other user, a gender criterion, an age criterion, and the like. In one embodiment, the interest indices may also be determined based additionally on a combination of the additional criteria. In still another embodiment, if two users are determined not to have interest indices for each other above a given threshold value, then the users might be determined not to be candidate mirrored friends. Other mirroring criteria may also be used to filter from the rank ordering users that might not be possible friends. In any event, the interest indices for the given user may be rank ordered, and at least some information about the related other users may be displayed to the given user, as possible mirrored friends. As used herein, the term “mirror,” is employed to indicate that a measurement of interests of one user based on how much the user's interests are reflected or mirrored by another user's interests in the same or similar tracked online activities.

In one embodiment, a determination may be made that an insufficient quantity of online activities has been tracked. In that embodiment, no friend list might be displayed. However, in another embodiment, a previous rank ordering of mirrored friends might be displayed.

By identifying possible friends based on a dependent interest affinity, which in turn is based on users' tracked online activities, the mirrored friends' list displayed to a user is expected to recognize common activities, and thereby enable a user's social network to grow based on common online activities—rather than merely based on a user's input to a survey, questionnaire, or the like.

It should be noted that embodiments as described herein are not limited to providing mirrored friend recommendations; other recommendations may also be provided. Thus, for example, mirror recommendations may also be provided for travel recommendations; dating recommendations; online activity recommendations such as blogs, games, or the like; or the like.

### Illustrative Operating Environment

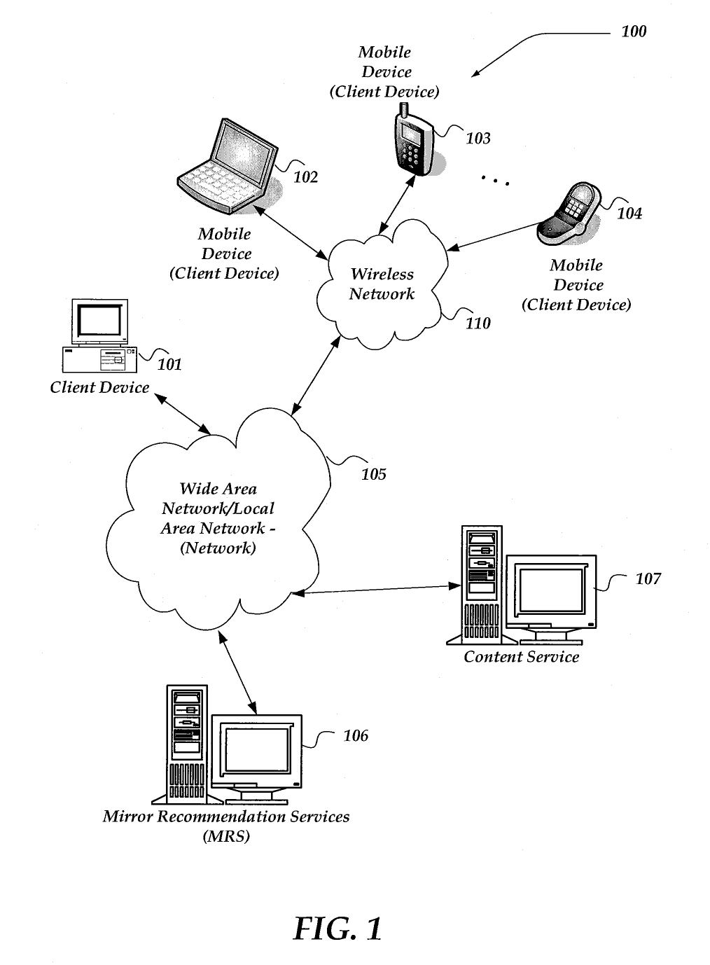

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Mirror Recommendation Services (MRS) 106, client devices 101-104, and content service 107.

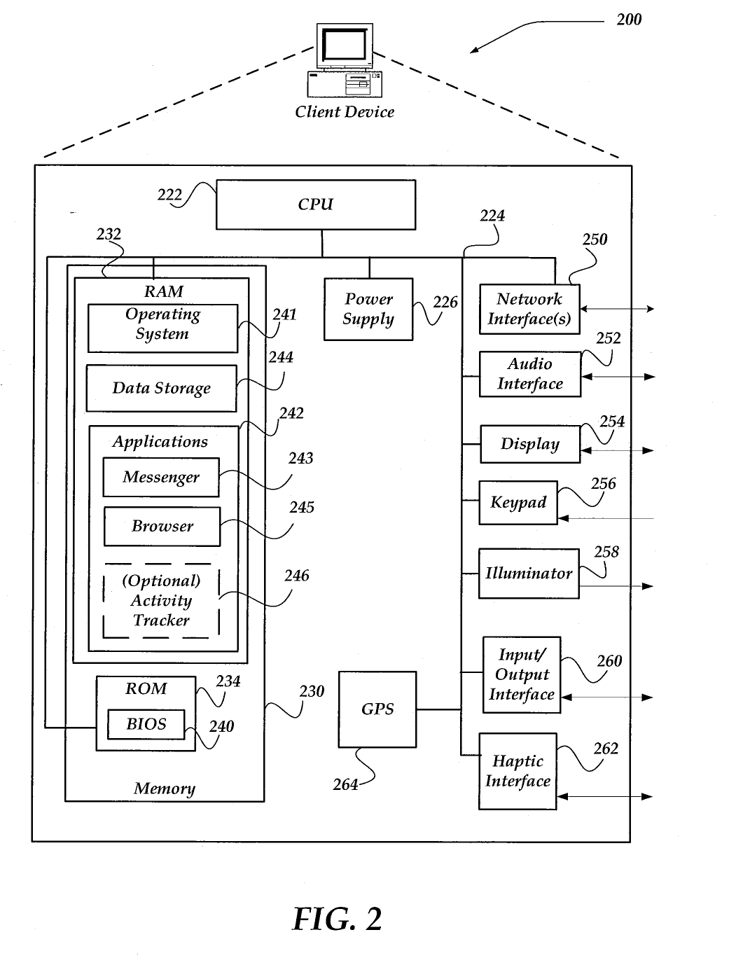

One embodiment of client devices 101-104 is described in more detail below in conjunction with FIG. 2. Generally, however, client devices 102-104 may include virtually any portable computing device capable of receiving and sending a message over a network, such as network 105, wireless network 110, or the like. Client devices 102-104 may also be described generally as client devices that are configured to be portable. Thus, client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information, including social networking information, performing various online activities, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 102-104 may operate over wired and/or wireless network.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 101-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent to MRS 106, content service 107, or other computing devices.

Client devices 101-104 may further be configured to include a client application that enables an end-user to log into an end-user account that may be managed by another computing device, such as content service 107, MRS 106, or the like. Such end-user account, for example, may be configured to enable the end-user to manage one or more online activities, including for example, search activities, social networking activities, browse various websites, make purchases, sell products/services, communicate with other users, or the like. However, participation in such online networking activities may also be performed without logging into the end-user account.

In one embodiment, online activities performed by a user of client devices 101-104 may be tracked. In one embodiment, the online activities may be tracked using an activity tracker that may reside within one or more of client devices 101-104. In another embodiment, the activity tracker may reside in another network device, such as content services 107, and/or MRS 106, or the like. In any event, a user that seeks to have candidate friends identified to the user may consent to having their online activities tracked. Such tracked activities may be tracked over a defined period of time, tracked continuously, or any of a variety of other time periods. When it is determined that a sufficient amount of online activities have been tracked, based on a threshold value, time period, or the like, the tracked activity data may be sent to MRS 106 for use in determining possible mirrored friends for the user, as described further below.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, MRS 106, content service 107, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

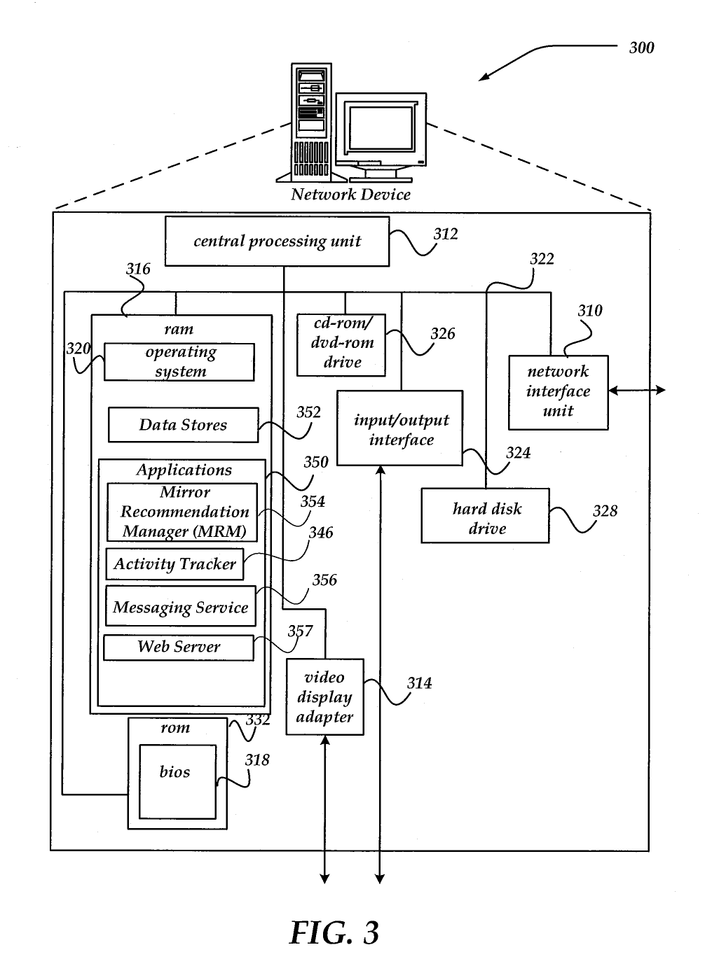

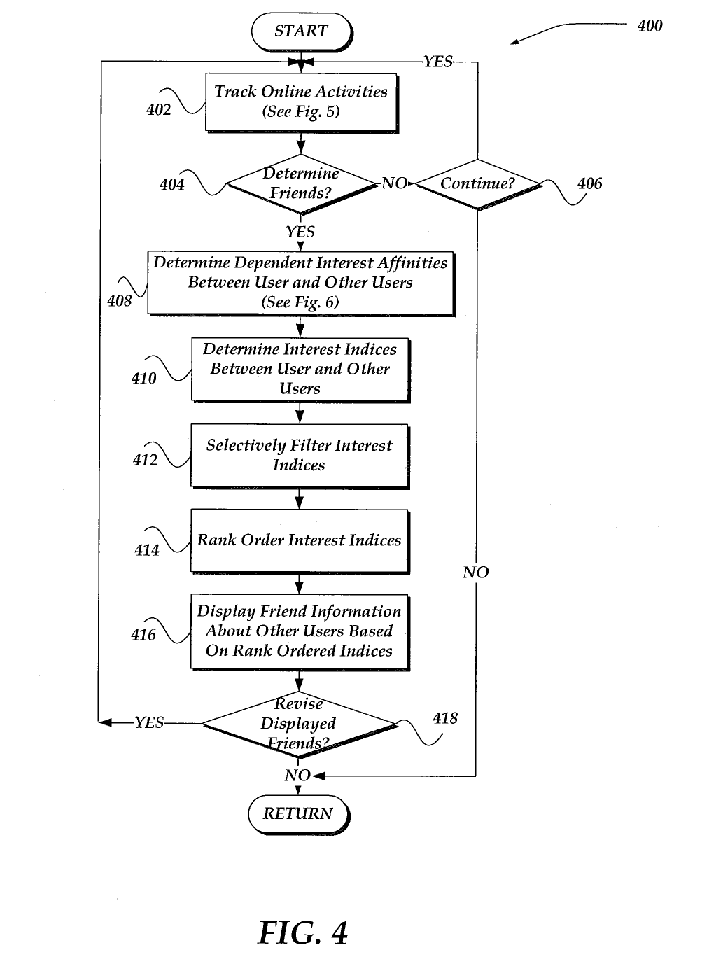

One embodiment of MRS 106 is described in more detail below in conjunction with FIG. 3. Briefly, however, MRS 106 may include any computing device capable of connecting to network 105 to employ tracked online activities of users and provide a rank ordered recommendation of mirrored friends to a user. In one embodiment, MRS 106 may determine the rank ordered recommendation by obtaining a plurality of tracked online activities for each of a plurality of consenting users. The plurality of tracked online activities may be classified into a plurality of interest categories, for which a weighted score may be generated for each interest based further on a quantity and/or quality of related activities. MRS 106 may determine a proportional score for each interest, which may then be used to generate dependent interest affinities between pairs of users. MRS 106 may further obtain interest indices for a given user and another user based on relevant dependent interest affinities. MRS 106 may then filter the resulting interest indices based on a variety of criteria as described further below. MRS 106 may provide a display of at least some information about the related other users to the given user based on the rank ordering, as a recommendation of possible mirrored friends. MRS 106 may employ, in one embodiment, processes such as those described below in conjunction with FIGS. 4-6 to perform at least some of its actions.

Devices that may operate as MRS 106 include various network devices, including, but not limited to personal computers, desktop computers, multiprocessor systems, microprocessor-based or programmable consumer electronics, network PCs, servers, network appliances, and the like.

Content service 107 represents any of a variety of network devices to provide content and/or services accessible by client devices 101-104. Such services include, but are not limited to merchant sites, educational sites, news sites, personal sites, music sites, video sites, blog sites, vlog sites, online dating sites, and/or any of a variety of networking sites. Content services 107 are not constrained to such sites, and may provide various services, including messaging services, or the like. In fact, content service 107 may provide virtually any content and/or service over which a user of client devices 101-104 may want to perform an online activity, which may subsequently be tracked.

Devices that may operate as content service 107 includes personal computers, desktop computers, multiprocessor systems, microprocessor-based or programmable consumer electronics, network PCs, servers, and the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including address books, buddy lists, aliases, user profile information, tracked online activities, interest categories, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, messenger 243, browser 245, and optional Activity Tracker (AT) 246.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may be employed.

In one embodiment, browser 245 may be configured to enable access to a graphical user interface provided by MRS 106, content service 107, or the like, of FIG. 1. In one embodiment, a user of client device 200 may input perform any of variety of online activities using browser 245, including, but not limited to browsing various web pages, conducting online searches, online purchases, online sales, downloading of content, uploading of content, performing various messaging activities, or the like. Clearly, such examples of online activities that a user may perform using browser 245 is not exhaustive, and therefore, should not be construed as limiting.

Messenger 243 may be configured to manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols, including, but not limited to various push and/or pull mechanisms for client device 200. In one embodiment, messenger 243 may interact with browser 245 for managing messages.

AT 246 represents a downloadable application, widget, or the like, useable to perform optional tracking of various online activities by a user of client device 200. In one embodiment, AT 246 might be configured to track virtually any activity that may be directed as being communicated over a network from and/or to client device 200. In one embodiment, such activities might include various search activities, including navigational, informational, and/or transactional searches. The tracked activities may also include information about a starting point for which the user starts a particular type of activity, including for example, a web-landing page, home page, or the like; as well as any navigational patterns the user may perform after the starting point on the network is obtained. AT 246 may further track various activities on social networking sites, including information about a type of network site. AT 246 may also record clicking behavior on various web pages by the user to identify such as purchases, browsing behavior, interests, and the like. AT 246 may also track group subscription and/or participations in online discussions; activities on review sites, including page views, comments, and the like; activities at various user aggregated ranking sites; activities at various query based sites; social bookmarking activities; information about commonly visited sites by the user, including, for example, news, entertainments, music, sites and so, forth. AT 246 may further track various shopping behaviors, including a type of shopping, items browsed and/or purchases, an amount spend, and the like. Where the user provides comments to a web site, blog, vlog, news item, or the like, such information may also be tracked. Messenger and/or mail activities may also be tracked. Furthermore, AT 246 may track information about activities on career and/or job portals; or virtually any other type of site. AT 246 may track a time and/or amount of activity consumed by the user in browsing sties; and a randomness of browsing activities (where, in one embodiment, randomness might be based on an index that indicates an amount of deviation from a determined normal browsing behavior, or the like). AT 246 may also track information about a network connection, including, but not limited to a connection speed, a connection type, a device used for browsing and/or performing other online activities, a connectivity location, such as whether the user is performing the activities at work, at home, or some other location. A time, duration, a quantity, and other quality and/or quantity characteristics for each activity may also be tracked. Again, such information listed above is not to be construed as exhaustive, and therefore is to be recognized as merely non-limiting, non-exhaustive examples, of possible online activities that may be tracked.

In one embodiment, AT 246 may determine whether there are sufficient tracked online activities for use in sending to another network device, such as MRS 106 of FIG. 1. Such determination may be based on an amount of different activities tracked over a period of time, or the like. For example, where the user performs online activities once within a given week, it might be determined insufficient information is available to determine a mirrored friend. In one embodiment, AT 246 might send a flag, signal, message, or the like, to the other network device indicating that insufficient information is obtained. In another embodiment, however, AT 246 may provide whatever information it has tracked over a given time period to the other network device. In such a situation, the other network device might then determine if sufficient information is received.

AT 246 might buffer a predefined amount of tracked activity data, and when the buffer has reached a defined threshold, send the information in the buffer to the other network device. In one embodiment, the buffer may be stored within data storage 244; however, other computer readable storage media may also be used. In one embodiment, AT 246 may time stamp the data that is sent to the other network device. In one embodiment, AT 246 might continuously track and/or provide tracked data to the other network device. In another embodiment, AT 246 might buffer data for a period of time, such as an hour, a day, a week, or the like, and provide such buffered data to the other network device based on a schedule, event, or the like.

It is noted that AT 246 is an optional component to client device 200. As such, tracking of a user's online activities may be performed through another network device, or even a plurality of network devices. Thus, in one embodiment, content service 107 and/or MRS 106 of FIG. 1 may track various online activities of a user of client device 200 instead of and/or in addition to AT 246. In still another embodiment, a plurality of devices, including client device 200 might track online activities, and provide the tracked activities to one or more network devices, such as MRS 106 for analysis.

In one embodiment, AT 246 may also classify the plurality of online user activities into a plurality of different interests. In one embodiment, the plurality of different interests might be predefined categories of interests. In one embodiment, the interests might be defined as a hierarchy related of interests. For example, interests associated with painting, drawing, photography, and the like, might be classified under a more general interest, such as art, or the like. In one embodiment, the categories may number between about 19,000 to about 20,000 categories. However, the invention is not so limited and other categories of interests and/or amount of categories may also be employed. In one embodiment, the categories may be generated based on an analysis of various information obtained from the activities. For example, such information might include Uniform Resource Identifiers (URI), Uniform Resource Locators (URLs), keywords within the tracked activities, tags associated with and/or within the tracked activities, content of a particular web site, a title, subject, or the like. Virtually any information within the tracked activities may be used to classify an activity. Where AT 246 classifies activities into interest categories, such classification information may also be provided to the other network device.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, MRS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer-readable storage media. Computer-readable storage media may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data stores 352 may include a database, text, spreadsheet, folder, file, or the like, that may be configured to maintain and store user account identifiers, user profiles, email addresses, IM addresses, and/or other network addresses; or the like related to a user for use in identifying users for mirror friend analysis. Data stores 352 may also store a tracked online activity data, interest category information, interest affinities, weighted scores, weightings, interest indices, and the like, based at least in part on processes described below in conjunction with FIGS. 4-6. Data stores 352 may further include program code, data, algorithms, and the like; for use by a processor, such as central processing unit (CPU) 312 to execute and perform actions. In one embodiment, at least some of data store 352 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Web server 357, messaging server 356, Activity Tracker (AT) 346, and Mirror Recommendation Manager (MRM) 354 may also be included as application programs within applications 350.

Web server 357 represent any of a variety of services that are configured to provide content, including messages, over a network to another computing device. Thus, web server 357 includes for example, a web server, a File Transfer Protocol (FTP) server, a database server, a content server, or the like. Web server 357 may provide the content including messages over the network using any of a variety of formats, including, but not limited to WAP, HDML, WML, SMGL, HTML, XML, cHTML, xHTML, or the like.

Web services 357 may also interact with MRM 354 and/or AT 346 for use in providing one or more user interfaces useable for registering a user for receiving mirror friend recommendations, obtaining consent for and performing tracking of online activities, and further for providing recommendations of friends to the user based on the mirrored analysis.

Messaging server 356 may include virtually any computing component or components configured and arranged to forward messages from message user agents, and/or other message servers, or to deliver messages to a local message store, such as data store 354, or the like. Thus, messaging server 356 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. Messaging server 356 may also be managed by one or more components of messaging server 356. Thus, messaging server 356 may also be configured to manage SMS messages, IM, MMS, IRC, RSS feeds, mIRC, or any of a variety of other message types. In one embodiment, messaging server 356 may enable users to initiate and/or otherwise conduct chat sessions, VOIP sessions, or the like. Messaging server 357 may also receive recommendations from MRM 354 for use in sending within messages that include the mirrored recommendations to a user. Thus, in one embodiment, messaging server 356 may be configured to interact with web server 357 and/or MRM 354 for use in messages associated with recommendations.

AT 346 is configured to operate similar to optional AT 246 described above in conjunction with FIG. 2. Thus, in one embodiment, AT 346 may track online activities for consenting users. In one embodiment, AT 346 may also classify the activities into one or more of a plurality of interests. AT 346 may further provide the information to MRM 354 for use in determining and providing to a user mirrored recommendations for display at a client device.

MRM 354 is configured and arranged to provide a rank ordered recommendation of possible mirrored friends (and/or other recommendations) to a user. In one embodiment, MRM 354 may determine the rank ordered listing by obtaining a plurality of tracked online activities for each of a plurality of consenting users from AT 346, and/or another source. MRM 354 may employ, in one embodiment, processes such as those described below in conjunction with FIGS. 4-6 to perform at least some of its activities. As noted elsewhere, however, MRM 354 may also provide mirrored recommendations to a given user for other activities, including, for example, travel recommendations, online activity recommendations, dating recommendations, or the like.

### Generalized Operation

The operation of certain aspects of the invention will now be described with respect to FIGS. 4-6. As discussed elsewhere, people come to social networking sites to interact and socialize with friends and to make new friends. The processes described below describe embodiments useable to help recommend potential friends based on users' tracked online activities. An index is generated that is based on a user's online behavior, and dependency relations between other user's activities. The approach includes finding a user's interest(s) based on their online activities. A score is assigned to each interest, which is proportional to a quality and quantity of activity for the interest. An interest affinity between every pair of users registered in the system may then be obtained (a subset of users may also be used). The interest affinity provides a quantitative measure of a possibility of friendship between two users. Interest indices are then obtained for various user relationships. In one embodiment, the interest indices are ranked, and/or filtered, and then provided to a user as a mirrored recommendation of possible friends. As mentioned above, the processes may also provide other recommendations, and is therefore not limited to friend recommendations.

It is noted that a non-limiting, non-exhaustive use case example is provided below to illustrate the concepts embodied below within the flow diagrams. The separation of the flow diagrams from the use case is directed towards simplifying readability of the logical flow diagrams.

FIG. 4 illustrates a logical flow diagram generally showing one embodiment of an overview process for providing mirrored recommendations. Process 400 of FIG. 4 may be implemented within MRS 106 of FIG. 1, in one embodiment. However, at least a portion of process 400 may also be implemented within one or more of client devices 101-104 of FIG. 1.

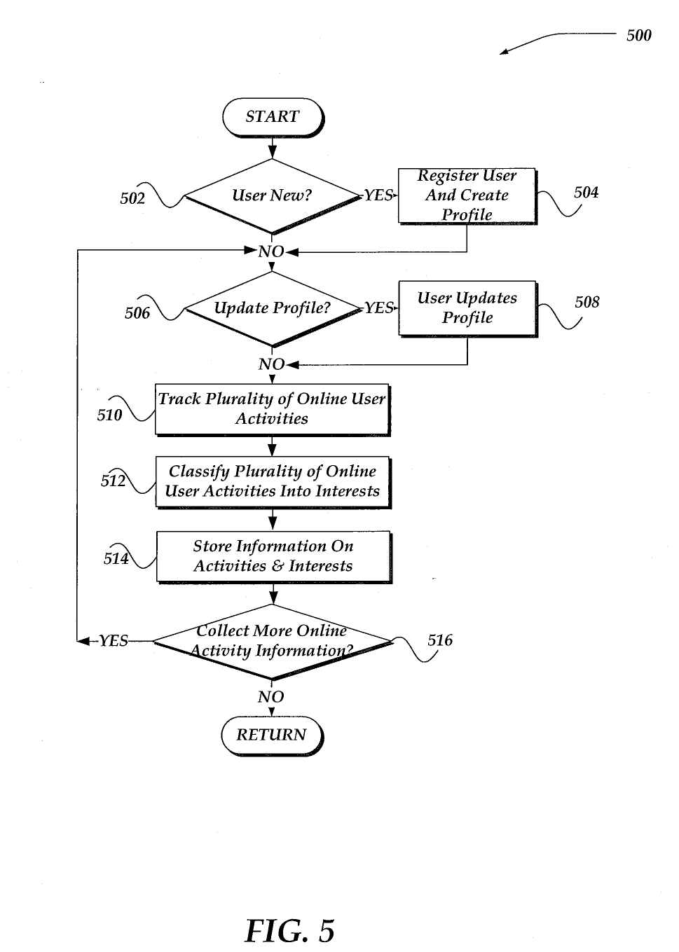

In any event, process 400 begins, after a start block, at block 402, which is described in more detail below in conjunction with FIG. 5. Briefly, however, at block 402, a user may register and/or otherwise consent to having online activities tracked and recommendations provided to the user. The consenting user's online activities may then be tracked, and in one embodiment, classified into a plurality of interests.

Processing continues next to decision block 404, where a determination is made whether to analyze the tracked activities to provide a recommendation—of friends, or of another recommendation. The determination may be based on a variety of criteria. For example, in one embodiment, it may be determined that a sufficient amount of online activities is to be tracked prior to making a recommendation. This might be tested to minimize a likelihood of providing recommendations on what statistically might be considered as too small of sample sizes. Thus, the amount of activities that may be defined as sufficient may be statistically determined based on a confidence level desired, to reduce a number of false positives (or negatives), or the like. In another embodiment, the criteria used at decision block 404 may also be based on a time interval. Thus, in one embodiment, a determination at decision block 404 might include determining whether a period of time, such as a day, a week, or the like, has passed since the tracking commenced. Other time periods, as well as other criteria may also be used. Thus, the criteria described above merely provide non-exhaustive, non-limiting examples of criteria. In any event, if the criteria are satisfied, processing flows to block 408; otherwise, processing branches to decision block 406.

At decision block 406 a determination is made whether to continue collecting and/or determining a recommendation. Such determination may be based on a variety of criteria, including, for example, the user providing feedback that requests that no more tracking and/or recommendations be performed. However, the criteria at decision block 406 may be also based on an insufficient amount of activity being tracked over an extended time period for the user, a service charge not being paid by the user for receiving the recommendations (should such a charge be implemented); or the like. In any event, should the determination be to continue, processing loops back to block 402; otherwise, processing may return to a calling process to perform other actions.

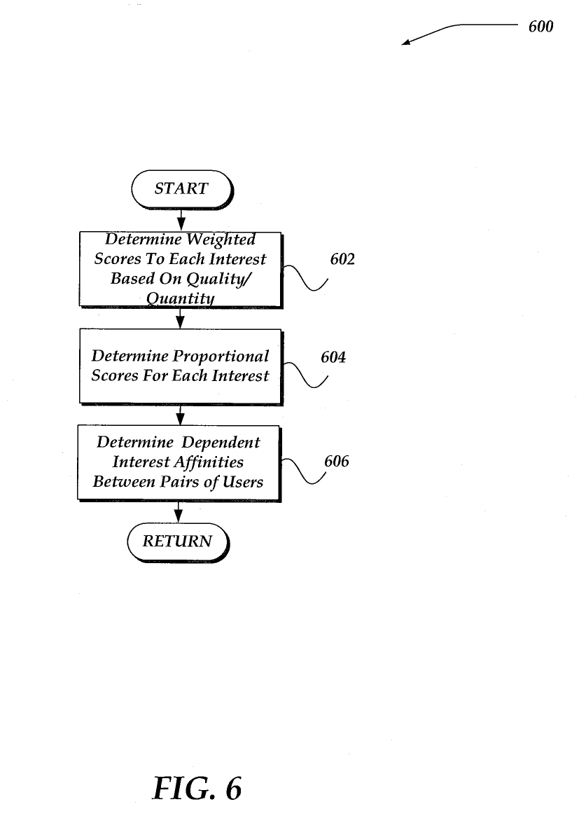

At block 408, dependent interest affinities between the user and other users may be determined. One embodiment of block 408 is described further below, however, in conjunction with FIG. 6. Briefly, however, at block 408, weighted scores are generated based on quantity and/or quality of activities by users. The weighed scores are then used to generate proportional scores for each interest for each user.

Processing then flows to block 410, where interest indices between the user and other users are generated that represent in part a dependency relationship of interests between the user and each other user.

Processing continues next to block 412, where the interest indices may be selectively filtered. In one embodiment, the interest indices may be filtered based on additional selection criteria. For example, in one embodiment, where it is determined that the user and another user reside and/or otherwise perform a majority of their online activities at a distance apart that is greater than some value, then the interest index of the other distant user might be filtered out or otherwise removed. Similarly, other criteria may be used to filter out other users, including based on information obtained from registration of the users, and/or from tracked activities. Such information might be age criterion that indicates that the user seeks other users around a particular age range.

In another embodiment, however, the determination of interest indices may include weighted factors such as distance, age, gender preferences, or the like. In this manner, the interest indices may incorporate, and thereby reflect additional criteria between users. Thus, block 412 may be optional, in this other embodiment.

In any event, processing flows to block 414, where the interest indices (the filtered indices or those indices that includes the additional criteria) are rank ordered. In one embodiment, a threshold value may be employed to truncate display of those relationship recommendations that result in an interest index below the threshold value. Processing then flows to block 416, where the rank ordered interest indices are employed to identify information about associated other users that might be considered as possible mirrored friends. Selected information about these possible friends may then be displayed to the user in a rank order corresponding to their associated interest indices. The user may then select to view more information about the possible friend identified in the displayed list, scroll through the list, or perform other actions. In one embodiment, the user may select to send a correspondence to the recommended friend. In one embodiment, the correspondence may be buffered or otherwise managed through a proxy, such as MRS 106, or the like, to maintain a level of security and/or privacy.

Processing may then flow to decision block 418, where a determination is made whether to revise the displayed recommended mirrored friends' list. This may be based on a variety of criteria, including, for example, whether the user chose not to select to correspond with any of the recommended friends, a time period having elapsed, or other criteria. In any event, if the list is to be revised, processing loops back to block 402; otherwise, processing may return to a calling process to perform other actions.

FIG. 5 illustrates a logical flow diagram generally showing one embodiment of an overview process for tracking online activities by users. Process 500 of FIG. 5 represents one embodiment of a process useable within block 402 of FIG. 4. However, the invention is not limited to this process, and other flows may also be used.

In any event, processing begins in process 500, after a start block, at decision block 502, where a determination is made whether this is a new user to the mirrored friend recommendation service. If so, processing flows to block 504; otherwise, processing flows to decision block 506.

At block 504, the new user may register for the service. In one embodiment, such registration might include providing selected information, including, for example, a name or alias, an email or other messaging address, and/or any other selection criteria that the new user might select to provide. In one embodiment, such other selection criteria may be optional. That is, because embodiments are configured to derive such other selection criteria based on the user's online activities, the new user need not provide such information. Moreover, in one embodiment, such entered information might be ignored by the service, or compared to the derived other criteria from the online activities. If the entered criteria is detected to deviate from the derived other criteria, the service may then select which one of the criteria to employ—the entered criteria, the derived other criteria, or to perform other actions, including, for example, collecting more online activity information to validate or revise the derived other criteria.

In one embodiment, at block 504 (and/or in block 508 below), the user may specify selected websites, activities, or the like, to exclude from being tracked. In this manner, the user may be enabled to preserve some privacy, while exposing other aspects of their life. Thus, for example, the user might use selected email addresses for business transactions, banking transactions, or the like, and thus prefer such activities to be excluded. Thus, the user may be provided with a capability of excluding selected activities from online tracking.

In one embodiment, the new user may indicate that they consent to having their online activities tracked. Such indication may be through a click-through agreement, or the like. Further, in one embodiment, while it is anticipated that the service may be provided free, in other embodiments, a fee might be charged to the new user. As such, at block 504, the user might specify how to pay for the service. In still another embodiment, the new user might agree to some other form of reciprocation for the use of the service, such as agreeing to receiving/viewing advertisements, recommending other users to the service, or the like. In any event, the registration process at block 504 is intended to provide a minimum level of complexity, and interaction with the new user, to not frustrate a new user with numerous forms, questions, surveys, or the like. Once the new user has registered, a new user profile is created, and processing flows to decision block 506.

At decision block 506, the user is provided with an opportunity to update their profile. If the user selects to, then processing flows to block 508; otherwise, processing flows to block 510.

At block 508, the user may modify virtually any aspect of their profile, including a name, alias, message address, or the like. Processing then continues to block 510.

At block 510, virtually any online activity of the user (minus possible user excluded activities) may then be tracked and recorded, including, but not limited to the type of information described above. Processing then continues to block 512, where the tracked activities may be classified into one or more of a plurality of interest categories. As discussed above, in one embodiment, the plurality of interest categories may be predefined; however, in another embodiment, the plurality of interest categories may be derived based on an analysis of the tracked activities themselves. In one embodiment, the online activities may be categorized based on an analysis of the content within the activities, tags associated within the activities, keywords, URLs, websites, or the like. Processing then flows to block 514, where the information from the online activities and interests are stored as described above.

Processing continues to decision block 516, where a determination is made whether to collect more online activity information. As noted above, the tracking of online activities may be continuous, periodic, or even a periodic. Thus, continuation of the tracking of online activities may be based on such criteria. However, continuation may also be based on whether the user has paid the requested fee (if there is one), has requested termination or suspension of their activities, or the like. If the tracking is to be terminated, processing returns to a calling process; otherwise, processing loops back to decision block 506.

FIG. 6 illustrates a logical flow diagram generally showing one embodiment of an overview process for use in determining interest affinities between a user and other users for use in determining mirrored recommendations. Process 600 of FIG. 6 may be employed as one embodiment of block 408 of FIG. 4. However, other processes may also be employed, without departing from the scope of the invention.

In any event, process 600 begins, after a start block at block 602, where a weighted score is determined for each interest identified from the classification of tracked online activities. In one embodiment, the weighting may be determined using a linear regression model. However, other mechanisms may also be used to determine the weightings.

Processing then moves to block 604, where a proportional score for each interest for each user is determined, as described further below in the non-limiting use case. Flowing next, to block 606, dependent interest affinities between the user and each other user are determined, as further described below. Process 600 then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

### Illustrative Use Case:

The following provides one non-limiting, non-exhaustive example of using the above to determine a mirror recommendation. It should be recognized that this use case example might include more or less interest categories for a given user. It may also be extended to include a plurality of other users. However, for simplicity, the use case below is employed to illustrate the above for two users, A and B.

As described above, each consenting user's online activities are tracked, and categorized into different interest categories. The user's interests are then scored based on a quantity and quality of the activity. As used herein, the term “quantity” refers to those characteristics that are measured, while the term “quality” refers to those characteristics that relate to intrinsic features of an activity. Thus, for example, a number of searches performed by a user might represent a quantitative measure, while reading of an article, providing remarks or comments about an article would represent a qualitative measure. It is noted that in determining the score, a number may be obtained for qualitative measures, although the measure remains qualitative. A number of remarks or comments provided by a user therefore may represent a qualitative measure. Thus, “quality” measures are typically those characteristics that involve additional evaluations to ‘convert’ to a metric.

In this example, if a user performs searches for paintings, visits painting blogs, write blogs about paintings, then such online activities may be classified as painting interests. The scoring may also be based on the quality of the content the user generates—such as reflected by a number of visitors to the user's blog, as well as a quantity of content generated and/or viewed by the user, an amount of time spent viewing the content, or the like. The following provides one non-limiting example of interests. Again, the following should not be construed as exhaustive and merely provides possible examples of interests, other interests may also be determined based on another user's online activities.

| Interest | Weighted Score Description |
|---|---|
| Painting | Score may be based on searches related to |
| | painting, painting blog visits, commenting |
| | on painting on various blogs or other sites, |
| | scripting painting blogs, or the like. |
| Photography | Score may be based on uploading, sharing, |
| | downloading, commenting, or other |
| | activities, determined to be related to photo |
| | sites, including reading/writing on |
| | photography, or the like. |

Based then on the tracked activities of users, a weighed score for each interest, for each user, may be determined. For example, in one embodiment, for the painting interests, the weighted score may be determined from:

weighted_score_painting=x(number of searches in category)+y(number of clicks in that category)+z(number of views in that category)+ . . .

Virtually all of the online activities may be mapped to an interest and considered for the above scoring. In one embodiment, the weights (x, y, z, . . . ) may be based on a linear regression model. However, other mechanisms may also be used.

A proportional score for each interest for each user may also be determined, using, for example, the following:

proportional_score_of_interest=(weighted_score_of_interest)/(total_score_all_interests)

In this example, interests of the user A are scored. As shown below, the painting interest has a determined weighted score of 200. This score is given in comparison to all of the users. In one embodiment, such score may be based on an evaluation over all users' activities for this interest category. In one embodiment, such value may range from zero to potentially infinity; however, in another embodiment, the maximum possible value might be limited to a finite value. Users determined not to have any online activity in a given interest would receive a zero score, whereas others having at least some online activity in the given interest would receive a weighted score based on their quantity and quality of activity. Those users having a determined maximum level of activity on a given interest (both quantitatively and qualitatively) might, in one embodiment, receive the maximum score. Although the examples illustrate integer values for weighed scores, the invention is not so limited, and non-integer values may also be determined.

The following illustrates one non-limiting example, then of weighted scores and proportional scores for two users, A and B, for various interests.

USER A

| Interests | Weighted score | Proportional score |
|---|---|---|
| Painting | 200 | 0.20 |
| Drawing | 300 | 0.30 |
| Stamp Collection | 250 | 0.25 |
| Reading | 250 | 0.25 |
| Total Score | 1000 | |

USER B

| Interests | Weighted score | Proportional score |
|---|---|---|
| Painting | 100 | 0.166 |
| Drawing | 400 | 0.677 |
| Stamp Collection | 10 | 0.169 |
| Reading | 90 | 0.152 |
| Total Score | 590 | |

A similar set of determinations would be performed for each of the other plurality of users for which online activities are being tracked. Dependent interest affinity values are then determined between each pair of users. Thus, in this example, a dependent interest affinity between users A and B may be determined based on:

affinity_of_{—}A_with_{—}B=Σ(weighted_score_of_{—}B)*(proportional_score_of_{—}A)

which is determined over each interest from 1-n. Using the above data, and continuing the example,

affinity_of_{—}A_with_{—}B=(100*0.20+(400*0.30)+(10*0.25)+(90*0.25)=165.

affinity_of_{—}B_with_{—}A=(200*0.166)(300*0.677)+(250*0.169)+(250*0.152)=278.525

Clearly, the above may be adjusted for many more or less interests than illustrated. Thus, the invention should not be construed as being constrained to merely these interests. Additionally, similar calculations may be performed over pairs of other plurality of users. Thus, calculations may be performed, for example, for A with C, A with D, C with A, D with A, B with C, B with D, C with B, and so forth, to provide dependent relationship affinities, where C and D represent other users in the plurality of users.

Thus, a first set of dependent interest affinities may be generated for a given user, A with each of the other users, such as A with B, A with C, and so forth. Similarly, a second set of dependent interest affinities may be generated for each of the other users with the given user, A, such as B with A, C with A, D with A, and so forth.

Interest indices may then be determined providing a quantitative value for a possible mirrored friendship between users. In one embodiment, the determination of the interest indices may be based on the following:

interest_index_between_two_users=k1(interest_affinity_of user_{—}A_with_{—}B)+k2(interest_affinity_of user_{—}B_with_{—}A)+ . . .

Where k1-kn represent additional weighting factors that may further be determined by various mechanisms, including, for example, a linear regression mechanism.

Similar interest indices may also be determined for user A with C, user A with D, user A with user E, and so forth, to generate a plurality of interest indices useable to be rank ordered for possible mirror friends to recommend to user A. That is, interest indices are generated from a combination of dependent interest affinities from the first set and the second set of dependent interest affinities discussed above between a given user, say A, and each of the other users in the plurality of users. Similar determinations may be performed for each of the other users in the plurality of users to provide recommendations to the other users.

As noted above, the determined interest indices may be filtered based on various criteria. However, in another embodiment, additional criteria may be included in the calculation. For example, the interest indices might be determined by:

interest_index_between_two_users=k1(interest_affinity_of user_{—}A_with_{—}B)+k2(interest_affinity_of user_{—}B_with_{—}A)+k3(distance measure)+k4(gender measure)+ . . .

In any event, the determined interest indices for a given user A as dependent upon or reflecting interests for each of the other users may be rank ordered. In one embodiment, then a larger a numeric value for an interest index, a more likely that the two users mirror or reflect common interests, and therefore are more likely to become friends.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative on the received data to perform actions, including:
for each user in a plurality of users, classifying a plurality of tracked online activities of the each user into at least one of a plurality of interest categories; and
for a given user within the plurality of users:
determining a first set of dependent interest affinities for the given user with each of the other users in the plurality of users based on a plurality of weighted scores for online activities of each of the other users times proportional scores for online activities of the given user over the plurality of interest categories;
determining a second set of dependent interest affinities for each of the other users with the given user based on the determined weighted scores for tracked online activities of the given user times proportional scores for tracked online activities of each of the other users over the plurality of interest categories;
determining interest indices for the given user based on a combination of dependent interest affinities from the first set and the second set of dependent interest affinities for the given user and one of the other users in the plurality of users to generate each interest index; and
using the determined interest indices to display an ordered listing of recommended friends to the given user.

2. The network device of claim 1, wherein the weighting for each of the weighted scores is based on a linear regression.

3. The network device of claim 1, wherein each weighted score is determined based on at least one qualitative characteristic or quantitative characteristic for the associated classified tracked online activities.

4. The network device of claim 1, wherein determining the interest indices further comprises additionally combining at least one criteria for the given user, wherein the at least one criteria is determined based on an analysis of the plurality of tracked online activities for the given user.

5. The network device of claim 1, wherein using the determined interest indices to display an ordered listing further comprises truncating the displayed listing based on a threshold level of associated interest index values.

6. The network device of claim 1, wherein the determined interest indices are further filtered based on at least one criteria submitted by the given user.

7. The network device of claim 1, wherein a user within the plurality of users is enabled to specify at least some online activities to be excluded from the plurality of tracked online activities for the user.

8. A system, comprising:
a first network device, comprising:
a processor that executes instructions that perform actions, including:
tracking online activities of each of a plurality of users; and
classifying the tracked online activities into a plurality of interest categories; and
a second network device, comprising:
a processor that executes instructions that perform actions, including:
for a given user within the plurality of users:
determining a first set of dependent interest affinities for the given user with each of the other users in the plurality of users based on the classified tracked online activities;
determining a second set of dependent interest affinities for each of the other users with the given user based on the classified tracked online activities;
determining interest indices for the given user based on a combination of dependent interest affinities from the first set and the second set of dependent interest affinities for the given user and one of the other users in the plurality of users to generate each interest index; and
using the determined interest indices to display an ordered listing of recommended friends to the given user.

9. The system of claim 8, wherein each dependent interest affinity within the first set of dependent interest affinities is determined based on a summation over the plurality of interest categories of weighted scores of another user within the plurality of users times a proportional score for the given user; and
wherein the second set of dependent interest affinities is determined based on a summation over the plurality of interest categories of weighted scores of the given user times a proportional score for the other user within the plurality of users.

10. The system of claim 8, wherein determining the interest indices further comprises additionally combining at least one criteria for the given user, wherein the at least one criteria is determined based on an analysis of the plurality of tracked online activities for the given user.

11. The system of claim 8, wherein the determined interest indices are further filtered based on at least one criteria submitted by the given user.

12. The system of claim 8, wherein a user within the plurality of users is enabled to specify at least some online activities to be excluded from the plurality of tracked online activities for the user.

13. The system of claim 8, wherein at least one of the first set or the second set of dependent interest affinities is determined based on at least one qualitative characteristic or quantitative characteristic for an associated classified tracked online activity.

14. A computer-readable storage medium having computer-executable instructions, the computer-executable instructions when installed onto a computing device enable the computing device to perform actions, comprising:
receiving a plurality of tracked online activities that are classified into a plurality of interest categories for each of a plurality of users; and
for a given user within the plurality of users:
determining a first set of dependent interest affinities for the given user with each of the other users in the plurality of users based on the classified plurality of tracked online activities;
determining a second set of dependent interest affinities for each of the other users with the given user based on the classified plurality of tracked online activities;
determining interest indices for the given user based on a combination of dependent interest affinities from the first set of dependent interest affinities and the second set of dependent interest affinities for the given user and one of the other users in the plurality of users to generate each interest index; and
using the determined interest indices to display an ordered listing of recommended friends to the given user.

15. The computer-readable storage medium of claim 14, wherein the interest categories are configured using a hierarchy of interest categories.

16. The computer-readable storage medium of claim 14, wherein determining the first set of dependent interest affinities further comprises:
for each user in the plurality of users:
determining a weighted score for each of the plurality of interest categories based on the classified plurality of tracked online activities;
generating a proportional score for each of the plurality of interest categories based on the weighted scores; and
for the given user, summing over the plurality of interest categories of weighted scores of another user within the plurality of users times a proportional score for the given user to generate each dependent interest affinity.

17. The computer-readable storage medium of claim 16, wherein the weighted scores are based further on a minimum/maximum range selected based on a comparison of all users within the plurality of users.

18. The computer-readable storage medium of claim 14, wherein displaying the ordered listing is based on the given user consenting to receiving an advertisement.

19. The computer-readable storage medium of claim 14, wherein the given user further specifies at least one online activity to be excluded from the tracked online activities for the given user.

20. The computer-readable storage medium of claim 14, wherein the displayed ordered listing is truncated to display recommended friends having an associated interest index above a threshold value.
